(19) United States
(12) Patent Application Publication
(10) Pub. No.: US 2026/0213666 A1
(43) Pub. Date: Jul. 23, 2026

(54) SYSTEMS AND METHODS FOR STABLE OPERATION OF ASYMETRIC HALF-BRIDGE CIRCUITS USING SLOPE COMPENSATION

(71) Applicant: Navitas Semiconductor Limited, Dublin (IE)

(72) Inventors: Zhenxu ZHA, Hangzhou (CN); Changhu YU, Shenzhen (CN); Yinshi YU, Shenzhen (CN); Haixiao CAO, Hangzhou (CN)

(73) Assignee: Navitas Semiconductor Limited, Dublin (IE)

(21) Appl. No.: 19/379,472

(22) Filed: Nov. 4, 2025

(30) Foreign Application Priority Data
Jan. 17, 2025 (CN) 202510084521.8

(51) Int. Cl. H02M 3/335; H02M 1/00; H02M 3/00

(52) U.S. Cl. CPC H02M 3/33571; H02M 1/0009; H02M 3/01

(57) ABSTRACT

A circuit. The circuit includes a first switch having a first gate terminal, a first source terminal and a first drain terminal, the first drain terminal coupled to a first terminal of an inductor, a second switch having a second gate terminal, a second source terminal and a second drain terminal, the second drain terminal coupled to a second terminal of the inductor, and a control circuit. In one aspect the control circuit is arranged to detect a first voltage signal representative of a current flowing through the second switch, generate a compensated reference signal using a slope compensation circuit, generate a gate control signal based on the compensated reference signal and control a conductivity state of the second switch by applying the gate control signal to the second gate terminal, thereby maintaining stable circuit operation over a broad range of duty cycles.

### CROSS REFERENCE TO RELATED APPLICATIONS

This application claims priority to Chinese provisional patent application no. 2025100845218, for “ SYSTEMS AND METHODS FOR STABLE OPERATION OF ASYMETROIC HALF-BRIDGE CIRCUITS USING SLOPE COMPENSATION” filed on Jan. 17, 2025, which is hereby incorporated by reference in entirety for all purposes.

### FIELD

The described embodiments relate generally to power converters, and more particularly, the present embodiments relate to systems and methods for stable operation of asymmetric half-bridge circuits using slope compensation.

### BACKGROUND

With the development of power electronics, the industry has put forward higher requirements for the power density of a switching power supply. In asymmetric half bridge (AHB) circuits, subharmonic oscillation can cause instability in the operation of the AHB circuit. Subharmonic oscillation may occur when the duty cycle exceeds 50% in peak current mode control. The oscillation may manifest as alternating long and short switching cycles at half the switching frequency. Traditional slope compensation methods used in buck converters are not directly applicable to AHB topologies. The resonant tank behavior in AHB circuits creates unique stability challenges not present in conventional topologies. Resonant capacitor voltage disturbances may affect the turn-on time of the low-side switch, leading to cycle-to-cycle variations. These variations in turn-on time can cause corresponding changes in magnetizing current. The magnetizing current variations can create a positive feedback loop that amplifies perturbations. There remains a need for improved stability control techniques specifically adapted for AHB power converter topologies.

### SUMMARY

In some embodiments, a circuit is disclosed. The circuit includes a first switch having a first gate terminal, a first source terminal and a first drain terminal, the first drain terminal coupled to a first terminal of an inductor; a second switch having a second gate terminal, a second source terminal and a second drain terminal, the second drain terminal coupled to a second terminal of the inductor; and a control circuit having an output terminal coupled to the second gate terminal, wherein the control circuit is arranged to: detect a first voltage signal representative of a current flowing through the second switch; generate a second voltage signal that is representative of a peak current reference signal that is based on a feedback signal; generate, by a slope compensation circuit, a compensation signal; generate a compensated reference signal by adding the compensation signal to the second voltage signal; generate a gate control signal based on a result of comparison of the first voltage signal and the compensated reference signal; and control a conductivity state of the second switch by applying the gate control signal to the second gate terminal, thereby maintaining stable circuit operation over a broad range of duty cycles.

In some embodiments, the control circuit further comprises a current sensing resistor coupled to the second switch and arranged to generate the first voltage signal.

In some embodiments, the compensation signal has a value that starts at a predefined point and has a negative ramp rate.

In some embodiments, the circuit is arranged to generate an output voltage such that the output voltage is reduced when an on-time of the second switch is longer.

In some embodiments, the slope compensation circuit is arranged to generate the compensation signal having a slope value that suppresses subharmonic oscillation when the circuit operates in continuous and discontinuous conduction modes.

In some embodiments, the first switch and the second switch form an asymmetric half-bridge configuration.

In some embodiments, the control circuit further comprises: a peak current reference circuit arranged to generate the second voltage signal based on the feedback signal; and a comparator having a first input terminal coupled to receive the first voltage signal, a second input terminal coupled to receive the compensated reference signal, and an output terminal arranged to provide the gate control signal.

In some embodiments, the circuit further includes a transformer having a primary winding coupled to the inductor and a secondary winding; a resonant capacitor coupled across the primary winding; and an output rectifier coupled to the secondary winding.

In some embodiments, the slope compensation circuit is arranged to generate the compensation signal with a fixed slope value.

In some embodiments, the slope compensation circuit is arranged to generate the compensation signal with a variable slope value based on operating conditions of the circuit.

In some embodiments, a method of operating a circuit is disclosed. The method includes providing an asymmetric half-bridge circuit having a first switch and a second switch coupled at a switch node, wherein the first switch is coupled to a first terminal of an inductor and the switch node is coupled to a second terminal of the inductor; detecting a voltage representative of a current flowing through the second switch; generating a peak current reference signal based on a feedback signal representative of an output parameter of the asymmetric half-bridge circuit; generating, by a slope compensation circuit, a compensation signal having a negative ramp rate; combining the compensation signal with the peak current reference signal to generate a compensated reference signal; comparing the detected voltage with the compensated reference signal to generate a comparison result; and controlling a gate terminal of the second switch based on the comparison result to maintain stable circuit operation and suppress subharmonic oscillation.

In some embodiments, the generating the compensation signal comprises generating a signal that starts at a predefined value and decreases with a negative slope during an on-time period of the second switch.

In some embodiments, the asymmetric half-bridge circuit operates with a duty cycle greater than fifty percent.

In some embodiments, the asymmetric half-bridge circuit operates at a fixed switching frequency.

In some embodiments, the method further includes: coupling a resonant capacitor across a primary winding of a transformer, wherein the inductor comprises a magnetizing inductance of the transformer; and suppressing voltage disturbances across the resonant capacitor.

In some embodiments, the detecting the voltage representative of the current comprises measuring a voltage across a current sensing resistor coupled in series with the second switch.

In some embodiments, the compensation signal has a slope value selected to prevent oscillation of an inductor current between successive switching cycles.

In some embodiments, the controlling the gate terminal comprises turning off the second switch when the detected voltage exceeds the compensated reference signal.

In some embodiments, a power converter system is disclosed. The power converter system includes: a transformer having a primary winding with a first terminal and a second terminal, a secondary winding, and a magnetizing inductance; a first switch having a first terminal coupled to an input voltage terminal, a second terminal coupled to the first terminal of the primary winding, and a control terminal; a second switch having a first terminal coupled to the first terminal of the primary winding, a second terminal coupled to a reference potential, and a control terminal; a resonant capacitor coupled across the primary winding; a current sensing element coupled to sense current through the second switch; a peak current reference circuit arranged to generate a reference signal based on a feedback signal representative of an output parameter of the power converter system; a slope compensation circuit arranged to generate a compensation signal having a negative slope during an on-time of the second switch; a summation circuit arranged to combine the reference signal and the compensation signal to produce a compensated reference signal; a comparator having a first input coupled to receive a signal from the current sensing element, a second input coupled to receive the compensated reference signal, and an output; and a control circuit coupled to the output of the comparator and arranged to control the control terminal of the second switch to prevent subharmonic oscillation in the power converter system.

In some embodiments, the slope compensation circuit is arranged to generate the compensation signal with a slope magnitude that maintains stability when the power converter system operates with a duty cycle greater than fifty percent.

### BRIEF DESCRIPTION OF THE DRAWINGS

FIG. 1 illustrates a schematic of an asymmetric half bridge (AHB) circuit with slope compensation, according to some embodiments;

FIG. 2A shows an operating inductor current of an AHB circuit used in current approaches having a duty cycle greater than 50%.

FIG. 2B shows an operating inductor current of an AHB circuit with slope compensation having a duty cycle greater than 50%, according to some embodiments;

FIG. 3A shows a schematic of an AHB circuit used in current approaches.

FIG. 3B shows the various current and node voltages of the AHB circuit of FIG. 3A;

FIG. 4 shows various current and node voltages of the AHB circuit of FIG. 1, according to some embodiments;

FIG. 5 shows compensation reference voltage generated by the slope compensation circuit of circuit of FIG. 1, according to some embodiments; and

FIG. 6 illustrates a method of compensating subharmonic oscillation in asymmetric half-bridge circuits, according to some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Circuits, devices and related techniques disclosed herein relate generally to power converters. More specifically, circuits, devices and related techniques disclosed herein relate to stable operation of asymmetric half-bridge (AHB) circuits using slope compensation. Circuits and techniques disclosed herein can be beneficial to prevent oscillations in AHB circuits. In some embodiments, a voltage representative of a current flowing through a low-side switch of an AHB circuit can be detected. The voltage can then be compared to a reference voltage where the reference voltage may be adjusted by a compensation value, and the result of the comparison can be used to drive a gate terminal of the low-side switch. In this way, the AHB circuit can operate with reduced subharmonic oscillation.

The disclosed embodiments provide systems and methods for achieving stable operation of asymmetric half-bridge (AHB) power converters through implementation of slope compensation techniques. The embodiments address subharmonic oscillation that may occur in asymmetric half-bridge circuits operating under specific conditions including peak current mode control, continuous conduction mode, discontinuous conduction mode, and duty cycles greater than fifty percent. The slope compensation approach may prevent oscillatory behavior that can degrade power conversion efficiency and system reliability. In conventional buck converters, the subharmonic oscillation may occur at a fixed frequency and CCM mode. However, for AHB power converters subharmonic oscillation may occur in prevent critical conduction mode and discontinuous mode. Embodiments of the disclosure can prevent oscillatory behavior in AHB power converters operating in current mode control, continuous conduction mode, discontinuous conduction mode, and duty cycles greater than fifty percent.

The core functionality may involve integration of a slope compensation circuit that adds a negative ramp compensation signal to the peak current mode control reference signal when the low-side switch is activated. This compensation may effectively suppress disturbances in the resonant capacitor voltage that would otherwise lead to unstable oscillatory behavior. The compensation signal may be synchronized with the switching timing of the low-side switch to provide precise control over the peak current reference modification during critical operating periods.

The embodiments may operate within power electronic systems where asymmetric half-bridge power converters are used for DC-DC conversion applications including switch-mode power supplies, battery charging systems, LED drivers, telecommunications power systems, and industrial power conversion equipment. The slope compensation technique may be particularly beneficial in applications requiring peak current mode control for improved transient response, continuous conduction mode and discontinuous conduction mode operation, and high efficiency power conversion with duty cycles exceeding fifty percent.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

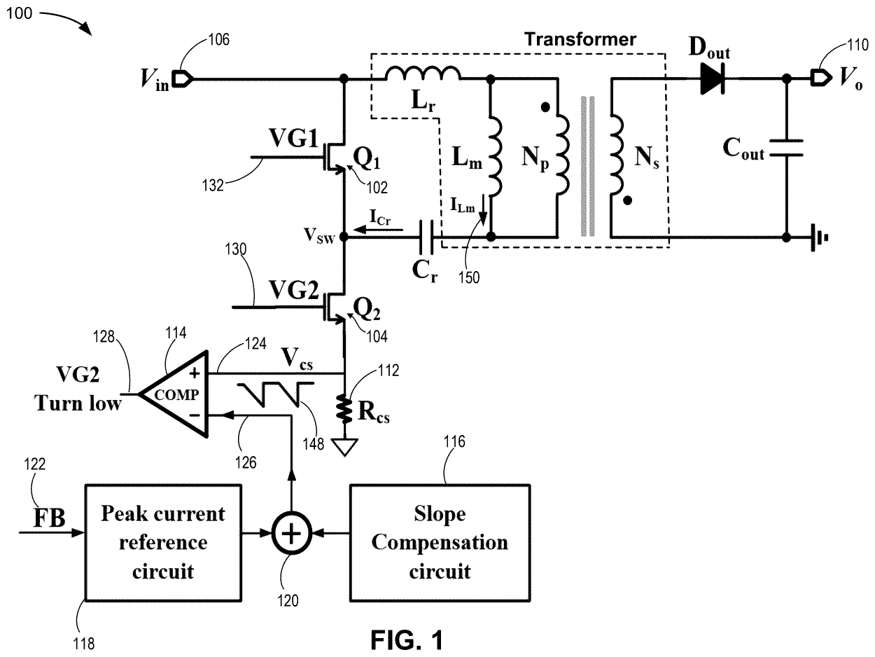

FIG. 1 illustrates an asymmetric half-bridge circuit 100 with slope compensation for stable power conversion operation, according to some embodiments. As shown in FIG. 1, the circuit 100 may include a high-side switch Q1 102 and a low-side switch Q2 104 connected at a switching node. The high-side switch Q1 102 may have a gate terminal 132 that receives control signals for switching operation. The low-side switch Q2 104 may have a gate terminal 130 that receives control signals from a comparator output terminal 128. An input terminal 106 may receive an input voltage Vin that powers the asymmetric half-bridge topology.

The circuit 100 may include a transformer with primary and secondary windings, where the primary side may include a resonant inductor Lr and magnetizing inductance Lm. A resonant capacitor Cr may be connected across the transformer primary winding to form a resonant tank circuit. The secondary side may include a rectifier diode Dout and output capacitor Cout that provide filtered DC output voltage Vo at output terminal 110. A sensing resistor 112 may be positioned to detect current flowing through the low-side switch Q2 104, generating a sensed voltage signal Vcs.

The control circuitry may include a comparator 114 having an inverting input terminal 126 and a non-inverting input terminal 124. The non-inverting input terminal 124 may receive the sensed voltage signal Vcs from sensing resistor 112. The inverting input terminal 124 may receive a compensated reference signal 148 that combines outputs from a peak current reference circuit 118 and a slope compensation circuit 116. A summation circuit 120 may add the peak current reference signal and slope compensation signal to generate the compensated reference signal 148.

The peak current reference circuit 118 may receive a feedback signal FB 122 that may be representative of the inductor current 150 in the magnetizing inductance Lm. The feedback signal FB 122 may provide information about the output voltage or current conditions for closed-loop control operation. The comparator 114 may generate an output signal at output terminal 128 that controls the gate terminal 130 of low-side switch Q2 104, thereby regulating the switching timing to maintain stable circuit operation.

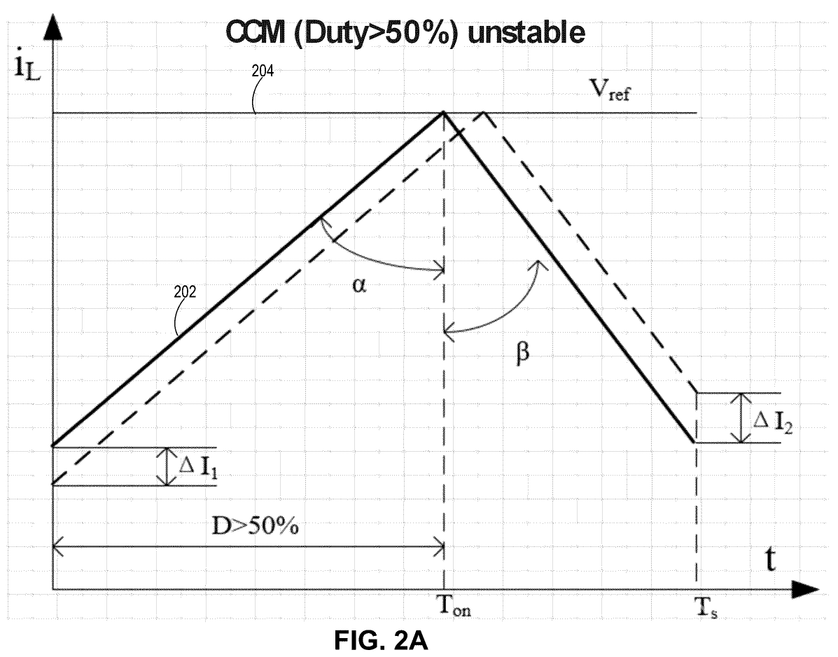

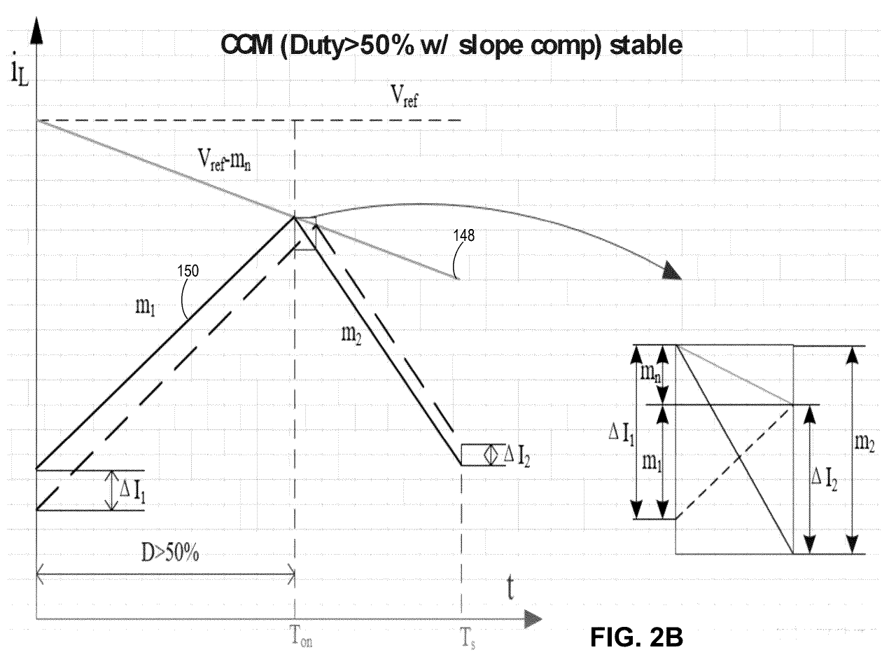

FIG. 2A illustrates a current waveform diagram of current approaches showing unstable operation in continuous conduction mode with duty cycle greater than fifty percent. As shown in FIG. 2A, an inductor current waveform 202 may exhibit subharmonic oscillation when operating without slope compensation. The current may rise with a slope a during the on-time period and fall with a slope β during the off-time period. An un-compensated reference signal 204 may remain constant, creating conditions where current ripple ΔI₁ during the rising portion and current ripple ΔI₂ during the falling portion may become unbalanced.

The time intervals Ton and Ts may represent the switch on-time and switching period respectively. When the duty cycle D exceeds fifty percent, the inductor current 202 may reach the reference voltage Vref at different points in successive switching cycles. This variation may cause the current differences ΔI₁ and ΔI₂ to grow progressively larger between cycles, leading to subharmonic oscillation that degrades power conversion stability and efficiency.

FIG. 2B illustrates a current waveform diagram showing stable operation in continuous conduction mode with duty cycle greater than fifty percent using slope compensation, according to some embodiments. As shown in FIG. 2B, the inductor current 150 may rise with slope ml during the on-time Ton and fall with slope m2 during the off-time. A compensated reference signal 148 may provide a negative slope that intersects with the rising inductor current 150 at a controlled point. The slope compensation may effectively balance the current ripples ΔI₁ and ΔI₂ to prevent progressive growth between switching cycles.

The compensated reference signal 148 may start at a predetermined voltage level and decrease linearly during the switch on-time period. This negative ramp may counteract the natural tendency for current imbalance that occurs when duty cycles exceed fifty percent. The intersection point between the inductor current 150 and compensated reference signal 148 may determine the precise turn-off timing for the low-side switch, ensuring consistent peak current levels across multiple switching cycles and maintaining stable power conversion operation.

The slope compensation circuit 116 may be implemented using various approaches to generate the compensation signal that is added to the peak current reference signal. Each approach may provide different advantages depending on the specific application requirements and operating conditions of the asymmetric half-bridge circuit.

In some embodiments, the slope compensation circuit 116 may employ a fixed slope compensation approach. The fixed slope compensation circuit may include a constant current source coupled to a timing capacitor to generate a linear ramp signal. The constant current source may provide a predetermined current value, such as 10 microamperes, that charges the timing capacitor during the on-time period of the second switch 104. The timing capacitor may have a capacitance value selected to achieve the desired slope compensation rate, such as 220 picofarads to generate a slope of approximately −45 millivolts per microsecond. A reset switch may be coupled in parallel with the timing capacitor to discharge the capacitor at the beginning of each switching cycle when the second switch 104 turns on.

The fixed slope compensation circuit may further include a voltage-to-current converter that converts the ramp voltage across the timing capacitor to a proportional current signal. The voltage-to-current converter may comprise an operational amplifier configured as a voltage follower with a precision resistor in the feedback path. The precision resistor may have a resistance value of 10 kilohms to provide the desired conversion ratio between the ramp voltage and the compensation current. An output buffer amplifier may be coupled to the voltage-to-current converter to provide the compensation signal with sufficient drive capability for the summing circuit 120.

In various embodiments, the slope compensation circuit 116 may implement a variable slope compensation approach. The variable slope compensation circuit may include a digitally controlled current source that adjusts the charging current for the timing capacitor based on operating conditions of the circuit. The digitally controlled current source may comprise a current digital-to-analog converter (DAC) with 8-bit resolution, providing 256 discrete current levels ranging from 1 microampere to 20 microamperes. A microcontroller or digital signal processor may monitor circuit parameters such as input voltage, output current, and duty cycle to determine the optimal slope compensation value.

The variable slope compensation approach may include sensing circuits to measure the operating parameters. An input voltage sensing circuit may comprise a resistive voltage divider with a ratio of 100:1 to scale the input voltage to a level suitable for analog-to-digital conversion. An output current sensing circuit may utilize a current transformer with a turns ratio of 1000:1 to provide galvanic isolation while measuring the output current. The sensed parameters may be digitized using a multi-channel analog-to-digital converter with 12-bit resolution and a sampling rate of 100 kilosamples per second.

The variable slope compensation circuit may store compensation parameters in a non-volatile memory such as electrically erasable programmable read-only memory (EEPROM). The memory may contain lookup tables that correlate operating conditions with optimal slope compensation values. The lookup tables may be populated during factory calibration or may be updated during operation based on performance measurements. A real-time algorithm may interpolate between stored values to provide smooth transitions in slope compensation as operating conditions change.

In some embodiments, the slope compensation circuit 116 may utilize a look-up table method for generating the compensation signal. The look-up table approach may employ a high-speed digital memory device such as a static random-access memory (SRAM) or a content-addressable memory (CAM) to store pre-calculated compensation values. The memory device may have a capacity of 64 kilobits organized as 8192 words of 8 bits each, providing sufficient resolution for various operating scenarios.

The look-up table method may include address generation circuitry that creates memory addresses based on real-time operating parameters. The address generation circuitry may comprise digital multipliers and adders that combine quantized values of input voltage, duty cycle, and switching frequency to form unique memory addresses. Each memory address may correspond to a specific operating condition, and the stored data at that address may represent the optimal slope compensation value for those conditions.

A digital-to-analog converter may be coupled to the output of the memory device to convert the stored digital compensation values to analog compensation signals. The digital-to-analog converter may be a 12-bit device with a voltage output range of 0 to 3.3 volts and a settling time of less than 1 microsecond. An analog output buffer may follow the digital-to-analog converter to provide the necessary current drive capability for the summing circuit 120.

The hardware implementation differences between the fixed slope, variable slope, and look-up table approaches may be significant. The fixed slope approach may require the fewest components and may consume the least power, making it suitable for cost-sensitive applications. The circuit board area for the fixed slope implementation may be approximately 25 square millimeters, including the timing capacitor, current source, and associated control circuitry.

The variable slope approach may require additional digital processing capability and sensing circuits, resulting in higher component count and power consumption. The circuit board area for the variable slope implementation may be approximately 100 square millimeters, including the microcontroller, current DAC, sensing circuits, and associated passive components. The variable slope approach may provide superior performance across varying operating conditions but at increased cost and complexity.

The look-up table approach may require the most sophisticated hardware implementation, including high-speed memory devices and digital signal processing capability. The circuit board area for the look-up table implementation may be approximately 150 square millimeters, including the memory device, address generation circuitry, digital-to-analog converter, and supporting components. The look-up table approach may offer the highest degree of optimization for specific applications but may require extensive characterization and calibration during development.

Each slope compensation approach may generate the compensation signal through different mechanisms. The fixed slope approach may generate a linear ramp signal that decreases at a constant rate during the on-time of the second switch 104. The ramp signal may start at a predetermined initial value, such as 100 millivolts, and decrease linearly to create the negative slope compensation. The slope rate may be determined by the ratio of the charging current to the timing capacitor value, providing a predictable and stable compensation characteristic.

The variable slope approach may generate compensation signals with dynamically adjusted slope rates based on real-time operating conditions. The compensation signal may start at an initial value that varies between 50 millivolts and 200 millivolts depending on the measured input voltage and load current. The slope rate may be adjusted between −20 millivolts per microsecond and −80 millivolts per microsecond to optimize stability margins under different operating scenarios.

The look-up table approach may generate compensation signals with arbitrary waveform shapes that are optimized for specific operating points. The compensation signal may include non-linear characteristics such as exponential decay or piecewise linear segments that provide enhanced stability performance. The look-up table may store 1024 sample points for each compensation waveform, allowing for high-resolution waveform generation with update rates up to 10 megasamples per second.

In alternative embodiments, the current sensing functionality may be implemented using a current sensing switch coupled to the low-side switch Q2 104 instead of the current sensing resistor 112. The current sensing switch may be connected in parallel with the low-side switch Q2 104. The current sensing switch may have a gate terminal that receives the same control signal as the gate terminal 130 of the low-side switch Q2 104.

The current sensing switch may be implemented as a scaled version of the low-side switch Q2 104 with a predetermined size ratio. The size ratio may be selected to provide adequate current sensing resolution while minimizing power dissipation. In some embodiments, the current sensing switch may have a width-to-length ratio that is 1/1000 of the low-side switch Q2 104, providing a current sensing ratio of approximately 0.1 percent. The current sensing switch may be fabricated using the same semiconductor process and device structure as the low-side switch Q2 104 to ensure matched electrical characteristics including threshold voltage, transconductance, and temperature coefficients.

A current-to-voltage conversion circuit may be coupled to the the current sensing switch to generate the sensed voltage signal Vcs. The current-to-voltage conversion circuit may include a precision current mirror with a conversion resistor to translate the sensed current into a proportional voltage signal. The current-to-voltage conversion circuit may further include an operational amplifier configured as a transimpedance amplifier to provide low input impedance and high output drive capability.

The current sensing switch approach may provide several advantages compared to the resistor-based current sensing method. The current sensing switch may eliminate the power dissipation associated with the sensing resistor 112, thereby improving overall circuit efficiency. The power savings may be particularly significant in high-current applications where the sensing resistor 112 would otherwise dissipate substantial power. The current sensing switch may also provide improved noise immunity since the sensed current signal may be processed at a higher impedance level before conversion to voltage.

The switching characteristics of the current sensing switch may be closely matched to those of the low-side switch Q2 104 due to the identical device structure and control signals. The current sensing switch may turn on and turn off simultaneously with the low-side switch Q2 104, ensuring accurate current representation throughout the switching cycle. The propagation delay between the gate control signal and the actual switching transition may be substantially identical for both switches, providing precise timing correlation between the sensed current and the actual switch current.

Timing considerations for the current sensing switch implementation may include compensation for any mismatch in switching characteristics between the current sensing switch and the low-side switch Q2 104. A timing adjustment circuit may be included to provide fine-tuning of the current sensing timing relative to the main switch timing. The timing adjustment circuit may include a variable delay element with adjustment range of plus or minus 10 nanoseconds to accommodate process variations and temperature effects. The timing adjustment may be calibrated during manufacturing or may be dynamically adjusted during operation based on performance measurements.

The current-to-voltage conversion circuit may be arranged to provide linear conversion characteristics over the full operating current range of the asymmetric half-bridge circuit 100. The conversion linearity may be maintained within 1 percent accuracy over current levels ranging from 10 percent to 100 percent of the maximum rated current. Temperature compensation may be incorporated into the current-to-voltage conversion circuit to maintain sensing accuracy over the specified operating temperature range of −40 degrees Celsius to 125 degrees Celsius.

The bandwidth requirements for the current sensing switch implementation may be determined by the switching frequency and current slew rate characteristics of the asymmetric half-bridge circuit 100. The current-to-voltage conversion circuit may provide a bandwidth of at least 10 megahertz to accurately capture current transitions during switching events. The phase response of the conversion circuit may be optimized to minimize phase shift at the switching frequency, ensuring proper timing relationship between the sensed current signal and the compensated reference signal 148 for stable comparator operation.

The slope compensation circuit 116 may generate the compensated reference voltage signal 148 through specific voltage generation methods that create the desired negative ramp characteristics. The compensated reference voltage signal 148 may be derived by combining the output from the peak current reference circuit 118 with a time-varying compensation signal that exhibits a controlled negative slope during the on-time period of the low-side switch Q2 104. The slope parameter Msc may define the rate of voltage decrease per unit time, typically expressed in millivolts per microsecond.

The voltage generation circuitry for creating the compensated reference voltage signal 148 may include a ramp generator circuit that produces the negative slope compensation component. The ramp generator circuit may comprise a constant current source connected to discharge a timing capacitor during the on-time of the low-side switch Q2 104. The constant current source may provide a predetermined discharge current, such as 15 microamperes, that removes charge from the timing capacitor at a controlled rate. The timing capacitor may have a capacitance value of 180 picofarads to achieve the desired slope characteristics when combined with the discharge current.

The Msc slope parameter may be determined by the ratio of the discharge current to the timing capacitor value, following the relationship Msc=I_discharge/C_timing. For the example values provided, the Msc slope parameter may be calculated as 15 microamperes divided by 180 picofarads, resulting in a negative slope of approximately −83 millivolts per microsecond. The negative sign may indicate that the compensated reference voltage decreases with time during the compensation period.

A voltage buffer amplifier may be coupled to the timing capacitor to provide the ramp voltage signal with appropriate drive capability for the summation circuit 120. The voltage buffer amplifier may be implemented using an operational amplifier configured in a unity-gain voltage follower configuration. The operational amplifier may have a slew rate specification of at least 50 volts per microsecond to accurately reproduce the ramp signal without distortion. The input impedance of the voltage buffer amplifier may be greater than 1 megohm to minimize loading effects on the timing capacitor.

The summation circuit 120 may combine the peak current reference signal from circuit 118 with the negative ramp signal to generate the compensated reference voltage signal 148. The summation circuit 120 may be implemented using an operational amplifier configured as an inverting summing amplifier with precision input resistors. The input resistors may have resistance values of 10 kilohms each to provide equal weighting of the input signals. A feedback resistor of 10 kilohms may be connected between the output and inverting input of the operational amplifier to establish unity gain for the summing operation.

The timing control for the ramp generation may be synchronized with the switching state of the low-side switch Q2 104. A timing control circuit may monitor the gate voltage at terminal 130 to determine when the low-side switch Q2 104 transitions to the conducting state. The timing control circuit may include a level detector that generates a control signal when the gate voltage exceeds a predetermined threshold, such as 2.5 volts. This control signal may activate the constant current source to begin discharging the timing capacitor, thereby initiating the negative ramp generation.

A reset mechanism may be incorporated to establish the initial voltage level of the compensated reference signal 148 at the beginning of each switching cycle. The reset mechanism may include a reset switch connected in parallel with the timing capacitor. The reset switch may be activated at the end of each switching cycle to rapidly charge the timing capacitor to a predetermined initial voltage level. The initial voltage level may be set to 150 millivolts above the baseline peak current reference voltage to provide the desired starting point for the negative ramp.

The slope compensation circuit 116 may include calibration circuitry to adjust the Msc slope parameter based on operating conditions or manufacturing variations. The calibration circuitry may comprise a digitally controlled current source that can adjust the discharge current in discrete steps. The digitally controlled current source may provide current adjustment in steps of 0.5 microamperes across a range from 5 microamperes to 25 microamperes. A calibration controller may monitor circuit performance parameters and adjust the discharge current to optimize the slope compensation effectiveness.

Temperature compensation may be implemented within the slope compensation circuit 116 to maintain consistent Msc slope characteristics across the operating temperature range. A temperature sensing element, such as a bandgap voltage reference with temperature coefficient, may provide a temperature-proportional signal. This temperature signal may be used to adjust the discharge current or timing capacitor effective value to compensate for temperature-induced variations in the slope generation circuitry. The temperature compensation may maintain the Msc slope parameter within ±5 percent of the nominal value over a temperature range from −40 degrees Celsius to 125 degrees Celsius.

The compensated reference voltage signal 148 may exhibit specific timing characteristics that align with the switching operation of the asymmetric half-bridge circuit 100. The negative ramp may begin simultaneously with the turn-on of the low-side switch Q2 104 and may continue for the duration of the on-time period. The ramp may terminate when the comparator 114 generates the turn-off signal at output terminal 128, or when a maximum on-time limit is reached. The maximum on-time limit may be set to prevent excessive duty cycles that could compromise circuit operation.

The amplitude range of the compensated reference voltage signal 148 may be designed to provide adequate compensation without interfering with normal peak current control operation. The initial amplitude may be set between 100 millivolts and 300 millivolts above the baseline peak current reference, depending on the specific application requirements. The maximum negative excursion may be limited to prevent the compensated reference from falling below the minimum expected current sensing voltage, ensuring reliable comparator operation throughout the switching cycle.

The slope compensation technique may specifically affect the transformer demagnetizing time through control of the magnetizing current peak value during each switching cycle. The magnetizing current ILm may reach different peak values depending on the compensated reference signal 148 intersection point with the sensed current signal. When the slope compensation circuit 116 generates a negative ramp that reduces the effective current threshold, the magnetizing current ILm may be limited to a lower peak value compared to operation without slope compensation. This reduced peak magnetizing current may directly correlate to a shorter demagnetizing time period following the turn-off of the low-side switch Q2 104.

The demagnetizing time period may be determined by the relationship Tdemag=Lm ×ILm(peak)/ Vdemag, where Lm represents the magnetizing inductance, ILm(peak) represents the peak magnetizing current at turn-off, and Vdemag represents the demagnetizing voltage across the magnetizing inductance. The slope compensation may reduce ILm(peak) through earlier termination of the switch conduction period, thereby proportionally reducing the demagnetizing time Tdemag. The shorter demagnetizing period may prevent excessive energy storage in the magnetizing inductance that would otherwise contribute to system instability.

The resonant capacitor Cr may exhibit modified discharging behavior during the demagnetizing phase when slope compensation is applied. During the demagnetizing period, the resonant capacitor Cr may discharge through the resonant inductor Lr and the reflected load impedance. The discharge current magnitude may be influenced by the initial conditions established during the magnetizing phase, which are directly controlled by the slope compensation technique. When the magnetizing current ILm(peak) is reduced through slope compensation, the initial energy stored in the resonant capacitor Cr at the beginning of the demagnetizing phase may also be reduced.

The relationship between slope compensation and the demagnetizing period may be characterized by the compensation slope parameter Msc and its effect on the current control loop dynamics. The compensation slope Msc may be selected to provide a specific reduction in the peak magnetizing current for a given operating condition. A steeper negative slope may result in greater reduction of ILm(peak) and correspondingly shorter demagnetizing times. The optimal slope compensation value may be determined by the relationship Msc=(m1−m2)/2, where m1 represents the current rising slope during the on-time and m2 represents the current falling slope during the off-time.

The control mechanism may contribute to system stability improvement by establishing a consistent relationship between the magnetizing current peak value and the demagnetizing time across successive switching cycles. Without slope compensation, variations in the resonant capacitor voltage Ver may cause the magnetizing current to reach different peak values in consecutive cycles, leading to varying demagnetizing times. The slope compensation may counteract these variations by adjusting the effective current threshold in a manner that compensates for the Ver disturbances, thereby maintaining more consistent demagnetizing periods.

The impact of compensation on resonant capacitor behavior during the demagnetizing phase may be observed through the capacitor voltage ripple characteristics. The resonant capacitor voltage Ver may experience a voltage change ΔVcr during each switching cycle, where ΔVcr=(1/Cr)×∫ICr dt over the switching period. The slope compensation may influence the integral of the capacitor current ICr by modifying the duration and magnitude of the current flow during both the magnetizing and demagnetizing phases. A reduced magnetizing current peak may result in lower capacitor current during the subsequent demagnetizing phase, leading to smaller voltage ripple ΔVcr.

The overall circuit operation may be affected by the slope compensation through the establishment of a negative feedback mechanism that opposes disturbances in the resonant tank behavior. When a disturbance causes the resonant capacitor voltage Vcr to increase, the resulting longer on-time tendency may be counteracted by the negative slope compensation, which reduces the effective current threshold and causes earlier switch turn-off. This earlier turn-off may limit the magnetizing current peak and reduce the subsequent demagnetizing time, thereby preventing the disturbance from propagating and growing in successive cycles.

The slope compensation may function as a stability mechanism by addressing the root causes of subharmonic oscillation through modification of the energy transfer characteristics during each switching cycle. The subharmonic oscillation may originate from the coupling between the magnetizing inductance Lm and the resonant capacitor Cr, where variations in the capacitor voltage may cause corresponding variations in the magnetizing current and switching timing. The slope compensation may break this coupling by introducing a controlled modification to the current threshold that compensates for the capacitor voltage variations, thereby preventing the oscillatory behavior from developing.

The demagnetizing behavior may be further influenced by the timing relationship between the slope compensation activation and the switch turn-off event. The slope compensation circuit 116 may be synchronized with the gate signal of the low-side switch Q2 104 to ensure that the compensation ramp begins precisely when the switch turns on and continues until the comparator 114 generates the turn-off command. This synchronization may ensure that the compensation effect is applied consistently during the critical period when the magnetizing current is building up and the resonant capacitor is being charged.

The resonant capacitor discharging characteristics may be modified through the slope compensation effect on the transformer coupling between primary and secondary circuits. During the demagnetizing phase, energy stored in the magnetizing inductance may be transferred to the secondary circuit through the transformer coupling. The slope compensation may influence this energy transfer by controlling the initial energy level in the magnetizing inductance, which directly affects the magnitude and duration of the energy transfer process. A lower initial energy level may result in faster completion of the energy transfer and shorter demagnetizing time.

The look-up table approach for generating the slope compensation circuit output may provide enhanced flexibility and optimization capabilities compared to fixed or variable slope compensation methods. The look-up table method may employ a structured data storage system that correlates specific operating conditions with pre-calculated optimal slope compensation values. This approach may enable the slope compensation circuit 116 to deliver precisely tailored compensation characteristics for each unique combination of input voltage, duty cycle, switching frequency, and load current conditions.

The look-up table structure may be organized as a multi-dimensional array where each dimension may represent a different operating parameter. A three-dimensional table structure may be implemented with input voltage as the first dimension, duty cycle as the second dimension, and output current as the third dimension. The input voltage dimension may be quantized into 32 discrete levels covering the range from 85 volts to 265 volts in steps of approximately 5.6 volts. The duty cycle dimension may be divided into 64 levels spanning from 10 percent to 90 percent in increments of 1.25 percent. The output current dimension may comprise 16 levels ranging from 10 percent to 100 percent of rated current in steps of approximately 6.25 percent.

The parameters stored within each look-up table entry may include the optimal slope compensation value Msc, the initial compensation voltage level, and the compensation duration for the corresponding operating condition. Each table entry may contain a 16-bit data word where the first 8 bits may represent the slope compensation value in units of millivolts per microsecond, the next 4 bits may encode the initial voltage level in steps of 10 millivolts, and the remaining 4 bits may specify the compensation duration in microsecond increments. This data organization may provide sufficient resolution for precise slope compensation control while maintaining reasonable memory requirements.

The table values may be accessed during operation through a real-time address generation process that converts the measured operating parameters into memory addresses. An analog-to-digital converter array may continuously sample the input voltage, duty cycle, and output current at a rate of 1 megasample per second. The digitized values may be processed through scaling and quantization circuits to generate address components that correspond to the look-up table dimensions. A digital address multiplexer may combine these address components to form the complete memory address for accessing the appropriate compensation parameters.

The indexing methodology may employ a hierarchical addressing scheme that optimizes memory access speed and reduces computational overhead. The most significant address bits may correspond to the input voltage dimension since this parameter may change relatively slowly compared to duty cycle and output current variations. The intermediate address bits may represent the duty cycle dimension, while the least significant bits may encode the output current level. This addressing hierarchy may enable efficient memory caching and prefetching strategies that reduce access latency during rapid operating condition changes.

The advantages of the look-up table approach may include superior optimization capability compared to analytical slope compensation methods. The look-up table values may be determined through extensive characterization testing or advanced simulation techniques that account for all circuit parasitics and non-linear effects. Each table entry may represent the globally optimal slope compensation value for the specific operating condition, potentially providing better stability margins and transient response compared to fixed or variable slope approaches that rely on simplified analytical models.

The look-up table method may provide rapid response to changing operating conditions since the compensation parameters may be retrieved directly from memory without requiring real-time calculations. The table access time may be less than 100 nanoseconds using high-speed static random access memory, enabling the slope compensation circuit 116 to adapt to load transients or input voltage variations within a single switching cycle. This rapid adaptation capability may be particularly beneficial in applications with highly dynamic load profiles or unstable input voltage conditions.

The memory requirements for the look-up table implementation may be calculated based on the table dimensions and data word size. For the three-dimensional structure described, the total memory capacity may be 32×64×16×16 bits, resulting in approximately 524,288 bits or 64 kilobytes of storage. This memory requirement may be satisfied using commercially available embedded memory devices such as serial flash memory or embedded SRAM within a microcontroller or digital signal processor. The memory cost may represent a small fraction of the overall system cost while providing significant performance benefits.

The indexing methodology may include interpolation capabilities to provide smooth compensation transitions between discrete table entries. When the measured operating parameters fall between quantized table values, a multi-dimensional linear interpolation algorithm may calculate intermediate compensation values. The interpolation process may use the four nearest table entries in three-dimensional space to compute a weighted average compensation value that corresponds to the actual operating condition. This interpolation approach may eliminate discontinuities in the compensation signal that could otherwise cause stability issues or audible noise.

The look-up table approach may incorporate adaptive learning capabilities that update table values based on measured system performance. Performance monitoring circuits may evaluate stability metrics such as duty cycle variation, output voltage ripple, and switching frequency deviation during operation. When performance degradation is detected, an optimization algorithm may adjust the corresponding table entries to improve system behavior. The updated table values may be stored in non-volatile memory to preserve the optimization results across power cycles.

The table structure may be expandable to accommodate additional operating parameters or higher resolution requirements. A four-dimensional table may include switching frequency as an additional dimension for applications with variable frequency operation. The resolution of existing dimensions may be increased by adding more quantization levels, though this expansion may require proportionally larger memory capacity. The modular table structure may allow selective resolution enhancement for critical operating regions while maintaining coarser resolution in less sensitive areas.

The look-up table implementation may include error detection and correction capabilities to ensure data integrity in harsh operating environments. Each table entry may include error correction code bits that enable detection and correction of single-bit errors caused by electromagnetic interference or memory device aging. A background memory verification process may periodically check table integrity and restore corrupted entries from backup storage. These reliability features may be particularly important in industrial or automotive applications where system failure could have serious consequences.

The variable slope compensation approach may implement dynamic adjustment of the slope compensation parameters based on real-time monitoring of circuit operating conditions. The slope compensation circuit 116 may include sensing circuitry that continuously monitors parameters such as input voltage, duty cycle, switching frequency, and load current to determine optimal compensation characteristics for each operating point. The sensing circuitry may comprise analog-to-digital converters with sampling rates of 500 kilosamples per second to capture rapid changes in operating conditions. A digital processing unit may analyze the sensed parameters and calculate appropriate slope compensation values using predetermined algorithms or lookup tables stored in memory.

The control mechanisms for variable slope compensation may include feedback loops that monitor system stability indicators and adjust compensation parameters accordingly. The feedback system may measure parameters such as duty cycle variation between switching cycles, peak current deviation from reference values, and resonant capacitor voltage ripple magnitude. When stability indicators exceed predetermined thresholds, the control algorithm may increase the slope compensation magnitude to enhance stability margins. The adjustment parameters may include slope rate modification in steps of 5 millivolts per microsecond, initial compensation voltage adjustment in 10 millivolt increments, and compensation duration changes in 100 nanosecond steps. The optimal slope values during operation may be determined through real-time optimization algorithms that minimize a cost function incorporating stability metrics, efficiency measurements, and transient response characteristics.

The conditions under which slope adjustment occurs may be defined by specific operating parameter ranges and system performance criteria. Slope adjustment may be triggered when the duty cycle exceeds 45 percent, when input voltage variations exceed 10 percent of nominal value, or when load current changes by more than 20 percent within a 1 millisecond time period. The adjustment process may also activate when measured stability indicators such as cycle-to-cycle duty cycle variation exceed 2 percent or when resonant capacitor voltage ripple exceeds 5 percent of the average capacitor voltage. The slope compensation circuit 116 may implement hysteresis in the adjustment thresholds to prevent oscillatory behavior in the compensation control system itself, with engagement thresholds set 10 percent higher than disengagement thresholds for each monitored parameter.

The operational relationship between the on-time of the second switch 104 and the output voltage may be established through the control mechanism that governs the energy transfer characteristics of the asymmetric half-bridge circuit 100. When the on-time of the second switch 104 increases, the magnetizing current ILm may reach a higher peak value before the comparator 114 generates the turn-off signal at output terminal 128. This increased peak magnetizing current may result in greater energy storage in the magnetizing inductance Lm during the conduction period. The higher energy level may cause the transformer to transfer more energy to the secondary side during the subsequent demagnetizing phase, which may lead to an increase in the output voltage Vo at terminal 110.

The slope compensation circuit 116 may create an inverse relationship between the on-time duration and the effective peak current threshold through the compensated reference signal 148. When the on-time of the second switch 104 becomes longer due to operating condition variations, the negative ramp of the compensated reference signal 148 may decrease to a lower voltage level during the extended conduction period. This lower reference voltage may cause the comparator 114 to generate the turn-off signal earlier in subsequent switching cycles, thereby reducing the peak magnetizing current and limiting the energy transfer to the secondary side. The feedback mechanism may operate through the feedback signal FB 122, which may monitor the output conditions and adjust the peak current reference circuit 118 to maintain regulation.

The circuit behavior that enables output voltage reduction when the second switch on-time is longer may involve the coordinated operation of the slope compensation circuit 116, comparator 114, and the resonant network formed by the resonant capacitor Cr and inductances Lr and Lm. The slope compensation may provide a stabilizing influence that counteracts disturbances in the resonant capacitor voltage that would otherwise cause progressive increases in both on-time and output voltage. This relationship may contribute to overall system regulation by preventing runaway conditions where longer on-times lead to higher output voltages, which could further extend on-times in a positive feedback loop. The stability enhancement may be achieved through the negative feedback characteristic introduced by the slope compensation, which may ensure that longer on-times result in lower effective current thresholds and ultimately shorter on-times in subsequent cycles.

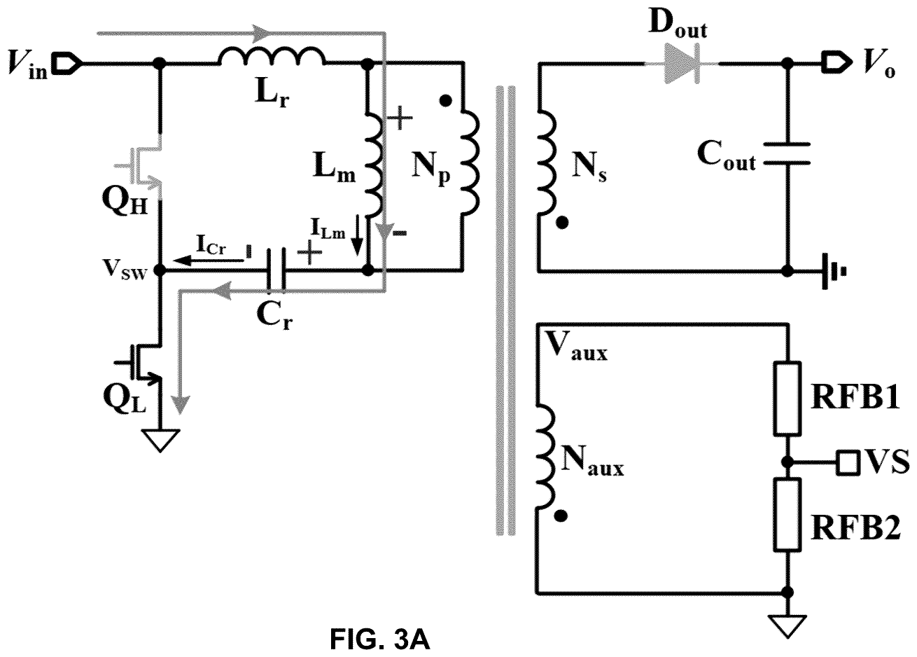

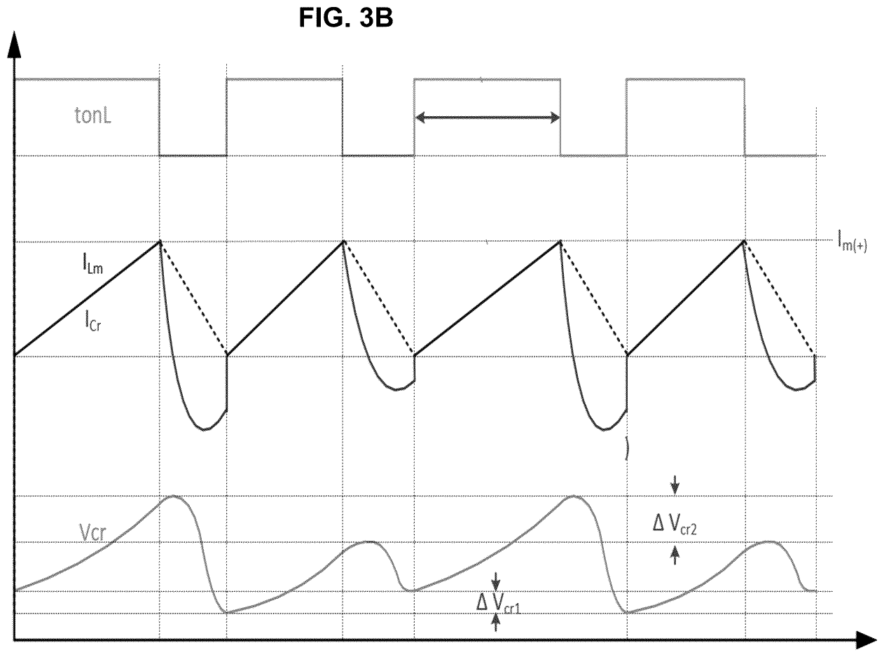

FIG. 3A illustrates a current approach for asymmetric half-bridge power conversion without slope compensation. As shown in FIG. 3A, the circuit may include an input voltage source Vin connected to a resonant inductor Lr and magnetizing inductance Lm in series with a transformer primary winding Np. A high-side switch QH may be connected between the input voltage and a switching node Vsw, while a low-side switch QL may be connected between the switching node and ground. A resonant capacitor Cr may be positioned across the transformer primary winding.

The secondary side may include a secondary winding Ns, rectifier diode Dout, and output capacitor Cout that generate output voltage Vo. An auxiliary winding Naux may provide auxiliary voltage Vaux to a feedback network comprising resistors RFB1 and RFB2 with a voltage sense node VS. Current flow paths may include ICr through the resonant capacitor Cr and ILm through the magnetizing inductance Lm. Without slope compensation, this configuration may be susceptible to subharmonic oscillation under certain operating conditions including continuous conduction mode with duty cycles exceeding fifty percent.

FIG. 3B illustrates timing waveforms for current approaches showing the relationship between switch timing and circuit parameters. As shown in FIG. 3B, a gate signal tonL may control the low-side switch timing with periodic high and low states. The magnetizing current ILm may exhibit a triangular waveform that rises and falls in synchronization with the switch timing. A resonant capacitor current ICr may show similar triangular characteristics but with different amplitude and phase relationships.

Mathematical relationships may govern the circuit operation, where tonL may equal Lm times ILm peak divided by the difference between input voltage Vin and resonant capacitor voltage Ver. The magnetizing inductance gain Km may be proportional to the voltage difference across the magnetizing inductance. The resonant capacitor voltage Ver may exhibit periodic variations with voltage changes ΔVcr1 and ΔVcr2 marked at specific time intervals. These voltage variations may contribute to instability in circuits operating without slope compensation.

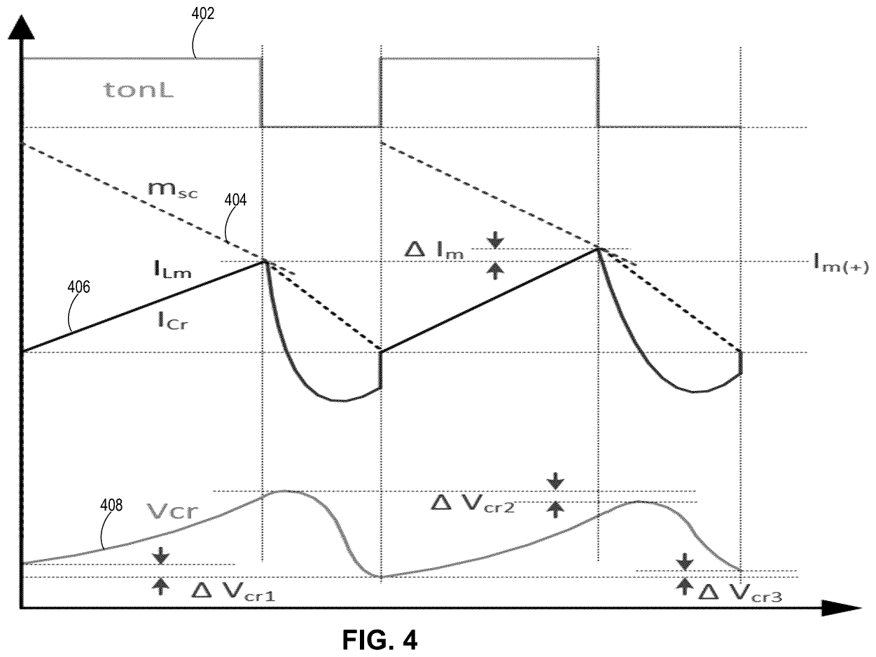

FIG. 4 illustrates timing waveforms showing the effect of slope compensation on circuit stability, according to some embodiments. As shown in FIG. 4, a gate voltage 402 of the low-side switch may provide switching control with defined on and off periods. An inductor current 406 may rise and fall in a sawtooth pattern synchronized with the switching timing. A compensated reference signal 408 may provide a downward sloping reference that intersects with the rising inductor current 406 at controlled points.

The slope compensation signal Msc may create a negative ramp that modifies the peak current reference during switch on-time periods. Current variations ΔIm and peak current Im(+) may be controlled through the intersection timing between the inductor current 406 and compensated reference signal 408. The resonant capacitor current ICr may exhibit controlled oscillation, while the resonant capacitor voltage Ver may show reduced voltage variations ΔVcr1, ΔVcr2, and ΔVcr3 compared to uncompensated operation. This reduction in voltage variation can contribute to improved circuit stability and reduced subharmonic oscillation.

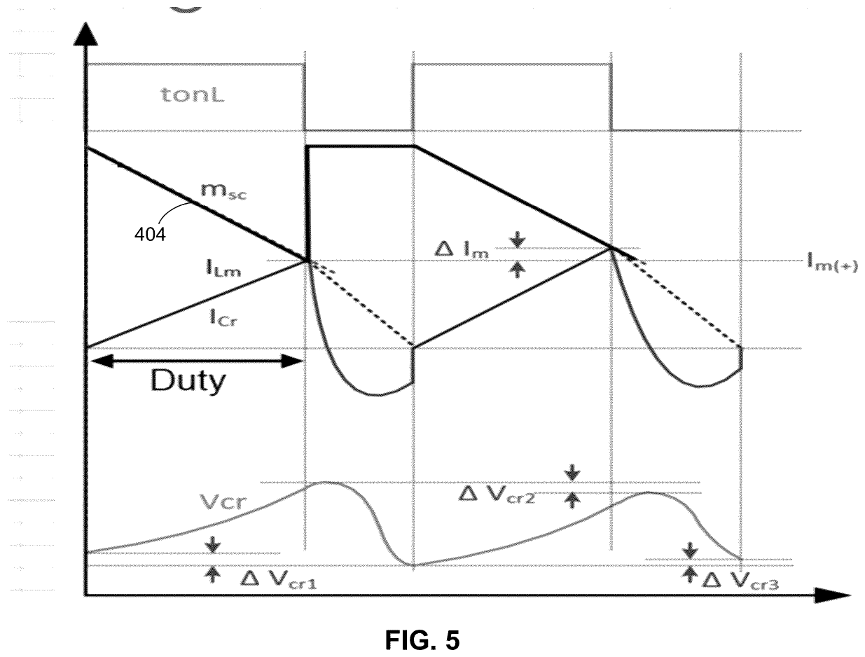

FIG. 5 illustrates waveform relationships showing the stabilizing effect of slope compensation across varying duty cycle conditions, according to some embodiments. As shown in FIG. 5, the gate timing signal tonL may provide switching control while a compensated reference signal 404 may create a sawtooth compensation pattern. The magnetizing current ILm and resonant capacitor current ICr may exhibit controlled triangular waveforms with balanced current variations.

The slope compensation may maintain consistent current ripple characteristics ΔIm and peak current levels Im(+) across different duty cycle operating points. The resonant capacitor voltage Vcr may show progressively smaller voltage variations ΔVcr1, ΔVcr2, and ΔVcr3, indicating improved stability as the slope compensation takes effect. This stabilization may occur across the full range of duty cycle operation, demonstrating the effectiveness of slope compensation in maintaining stable power conversion under varying load and line conditions.

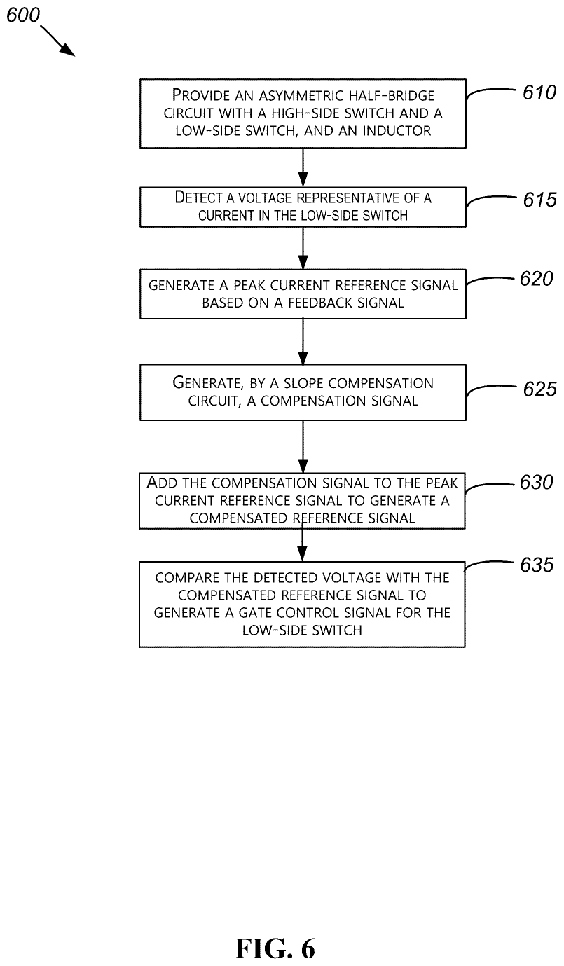

FIG. 6 illustrates a method 600 of compensating subharmonic oscillation in asymmetric half-bridge circuits, according to some embodiments. As shown in FIG. 6, the method may begin at step 610 by providing an asymmetric half-bridge circuit with a high-side switch and a low-side switch, and an inductor. The circuit configuration may include the necessary power stage components for DC-DC power conversion with transformer isolation.

At block 615, the method may detect a voltage representative of a current in the low-side switch. This detection may be accomplished using a current sensing resistor, current transformer, or other current sensing apparatus that generates a voltage signal proportional to the switch current. At block 620, the method may generate a peak current reference signal based on a feedback signal. The feedback signal may be derived from output voltage or current sensing and processed through error amplification and compensation networks.

At block 625, the method may generate, by a slope compensation circuit, a compensation signal. The compensation signal may comprise a negative ramp that begins at a predetermined level and decreases linearly during the switch on-time period. At block 630, the method may add the compensation signal to the peak current reference signal to generate a compensated reference signal. This addition may be performed using analog summation circuitry or digital signal processing techniques.

At block 635, the method may compare the detected voltage with the compensated reference signal to generate a gate control signal for the low-side switch. The comparison may be performed using a high-speed analog comparator that generates switching commands when the sensed current exceeds the compensated reference threshold. This gate control signal may then be applied to the low-side switch gate terminal to control switching timing and maintain stable circuit operation across varying operating conditions. It will be appreciated that method 500 is illustrative and that variations and modifications are possible. Steps described as sequential may be executed in parallel, order of steps may be varied, and steps may be modified, combined, added or omitted.

The methods described herein may be performed by one or more actors, systems, or components in various combinations. The stages of the methods may be re-arranged, combined, or performed in different sequences without departing from the scope of the disclosure. Additional stages may be added or certain stages may be omitted as appropriate for specific implementations. The methods may be executed automatically, manually, or through a combination of automated and manual processes.

The resonant capacitor Cr may be connected across the primary winding of a transformer. The resonant capacitor Cr may form part of the resonant network that includes leakage inductance Lr and magnetizing inductance Lm. A current sensing resistor Rs 112 may be positioned in series with the low-side switch Q2 104 to provide a voltage signal Vcs that may be representative of the current flowing through the low-side switch Q2 104. The voltage signal Vcs may be applied to an inverting input terminal 126 of a comparator 114.

The peak current reference circuit 118 may receive a feedback signal FB 122 that may be representative of the output voltage or output current of the asymmetric half-bridge circuit 100. The peak current reference circuit 118 may generate a peak current reference signal based on the feedback signal FB 122. The peak current reference signal may establish a baseline threshold for controlling the switching behavior of the low-side switch Q2 104.

In some embodiments, the slope compensation circuit 116 may also receive the feedback signal FB 122 and may generate a compensation signal. The compensation signal may have a negative slope characteristic that may be synchronized with the switching timing of the low-side switch Q2 104. The compensation signal may be generated during the on-time period of the low-side switch Q2 104 to provide dynamic modification of the peak current reference.

The summing circuit 120 may combine the output of the peak current reference circuit 118 with the output of the slope compensation circuit 116 to generate a compensated reference signal 148. The compensated reference signal 148 may be applied to a non-inverting input terminal 124 of the comparator 114. The comparator 114 may compare the voltage signal Vcs from the current sensing resistor Rs 112 with the compensated reference signal 148.

When the voltage signal Vcs exceeds the compensated reference signal 148, the comparator 114 may generate an output signal at its output terminal 128. The output signal may be used to control the gate terminal 130 of the low-side switch Q2 104, causing the switch to turn off. This control mechanism may prevent the current through the low-side switch Q2 104 from exceeding the compensated reference level.

The high-side switch Q1 102 may be controlled by a separate gate drive signal applied to its gate terminal 132. The high-side switch Q1 102 and low-side switch Q2 104 may operate in a complementary manner with appropriate dead time to prevent shoot-through current. The switching node between the two switches may be connected to the primary winding of the transformer through the resonant network.

The output terminal 110 may provide the regulated output voltage Vo after rectification and filtering of the secondary winding voltage. The inductor current 150 may flow through the magnetizing inductance Lm and may be influenced by the switching control provided by the slope compensation technique. The slope compensation may reduce variations in the inductor current 150 between successive switching cycles, thereby maintaining stable operation of the asymmetric half-bridge circuit 100.

The slope compensation circuit 116 may include a ramp generator that produces a compensation signal with predetermined characteristics. The ramp generator may comprise analog circuitry that generates a linear voltage ramp synchronized with the switching timing of the low-side switch Q2 104. The compensation signal may have a negative slope that begins at a predetermined voltage level when the low-side switch Q2 104 turns on and decreases linearly during the on-time period.

The slope of the compensation signal may be adjustable to accommodate different operating conditions and circuit parameters. In some embodiments, the slope compensation circuit 116 may include programmable resistor-capacitor networks that determine the ramp rate. The compensation signal amplitude may be scaled based on the duty cycle of the asymmetric half-bridge circuit 100 to provide optimal stability across varying operating points.

The slope compensation circuit 116 may include timing control circuitry that synchronizes the compensation signal generation with the gate timing of the low-side switch Q2 104. The timing control circuitry may receive switching signals from the gate drive logic to ensure precise alignment between the compensation ramp and the switch conduction period. This synchronization may be achieved through digital logic circuits or analog timing networks.

In some embodiments, the slope compensation circuit 116 may include amplitude control circuitry that adjusts the compensation signal magnitude based on operating conditions. The amplitude control circuitry may receive input signals representative of input voltage, output load, or duty cycle to dynamically scale the compensation signal. This adaptive compensation may optimize stability performance across varying line and load conditions.

The current sensing resistor Rs 112 may be implemented as a precision low-value resistor positioned in the source path of the low-side switch Q2 104. The sensing resistor Rs 112 may generate a voltage signal Vcs that may be proportional to the instantaneous current flowing through the low-side switch Q2 104. The voltage signal Vcs may be conditioned through amplification or filtering circuitry before being applied to the comparator 114.

Alternative current sensing methods may be employed in place of the sensing resistor Rs 112. A current transformer may be positioned around the low-side switch Q2 104 conductor to provide galvanically isolated current sensing. Hall-effect current sensors may be used to detect magnetic fields generated by current flow. MOSFET-based current sensing may utilize the on-resistance characteristics of the low-side switch Q2 104 to derive current information.

The comparator 114 may be implemented as a high-speed analog comparator with propagation delays suitable for the switching frequency of the asymmetric half-bridge circuit 100. The comparator 114 may include input offset compensation circuitry to minimize threshold errors. Hysteresis may be incorporated into the comparator 114 to prevent oscillation around the switching threshold.

The output terminal 128 of the comparator 114 may drive gate control circuitry that interfaces with the gate terminal 130 of the low-side switch Q2 104. The gate control circuitry may include level shifting circuits to provide appropriate voltage levels for switch control. Current amplification may be provided to supply sufficient gate drive current for rapid switching transitions.

The transformer in the asymmetric half-bridge circuit 100 may include multiple windings configured for the desired voltage conversion ratio. The primary winding may be connected to the switching node between the high-side switch Q1 102 and low-side switch Q2 104. Secondary windings may provide isolated outputs with rectification and filtering. An auxiliary winding may provide power for control circuitry and feedback signal generation.

The resonant capacitor Cr may be selected to resonate with the leakage inductance Lr at the desired operating frequency. The resonant capacitor Cr may be implemented using film capacitors, ceramic capacitors, or other suitable dielectric technologies. The capacitor value may be chosen to achieve zero-voltage switching conditions for improved efficiency.

The magnetizing inductance Lm may store energy during the on-time of the low-side switch Q2 104 and transfer energy to the secondary side during the off-time. The magnetizing inductance value may be selected to achieve the desired current ripple characteristics and energy transfer requirements. The inductor current 150 flowing through the magnetizing inductance Lm may be influenced by the slope compensation technique to maintain stable operation.

The feedback signal FB 122 may be derived from output voltage sensing, output current sensing, or a combination of both. Voltage divider networks may scale the output voltage to appropriate levels for the control circuitry. Current transformers or sensing resistors may provide output current information. Error amplifiers may process the feedback signals to generate control signals for the peak current reference circuit 118.

The peak current reference circuit 118 may include error amplification and compensation networks that process the feedback signal FB 122. The error amplifier may compare the feedback signal FB 122 with an internal reference voltage to generate an error signal. Compensation networks may include resistor-capacitor combinations that provide appropriate loop stability and transient response characteristics.

The summing circuit 120 may be implemented using operational amplifiers configured as analog adders. The summing circuit 120 may receive the peak current reference signal from the peak current reference circuit 118 and the compensation signal from the slope compensation circuit 116. The output of the summing circuit 120 may be the compensated reference signal 148 that combines both input signals with appropriate scaling.

The gate terminals 130 and 132 of the low-side switch Q2 104 and high-side switch Q1 102 respectively may receive control signals from gate driver circuits. The gate driver circuits may provide level shifting, current amplification, and isolation as required for proper switch operation. Dead-time generation may be incorporated to prevent simultaneous conduction of both switches.

The input terminal 106 may receive DC input voltage from various sources including battery systems, rectified AC mains, or other DC power supplies. Input filtering may be provided to reduce input current ripple and electromagnetic interference. The input voltage range may be designed to accommodate variations in the source voltage while maintaining stable operation.

The output terminal 110 may provide regulated DC output voltage through rectification and filtering of the transformer secondary voltage. Output filtering may include inductors and capacitors to reduce output voltage ripple. Output voltage regulation may be maintained through the closed-loop control system that includes the feedback signal FB 122 and associated control circuitry.

In some embodiments, combination of the circuits and methods disclosed herein can be utilized to provide for stable operation of asymmetric half-bridge (AHB) circuits using slope compensation. Although circuits and methods are described and illustrated herein with respect to several particular configuration of AHB converter circuits, embodiments of the disclosure are suitable for providing stable operation in other power converter circuits, such as, but not limited to, flyback converters, ACF, AHB, and LLC converters, and other switching converter architectures.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the switch in use and/or operation in addition to the orientation depicted in the figures. For example, if the switch in the figures is turned over, elements described as a “bottom” surface can then be oriented “above” other elements or features. The switch can be otherwise oriented (e.g., rotated 90 degrees or at other orientations) and the spatially relative descriptors used herein interpreted accordingly.

Terms “and,” “or,” and “and/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “in an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “in an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a first switch having a first gate terminal, a first source terminal and a first drain terminal, the first drain terminal coupled to a first terminal of an inductor;
a second switch having a second gate terminal, a second source terminal and a second drain terminal, the second drain terminal coupled to a second terminal of the inductor; and
a control circuit having an output terminal coupled to the second gate terminal, wherein the control circuit is arranged to:
detect a first voltage signal representative of a current flowing through the second switch;
generate a second voltage signal that is representative of a peak current reference signal that is based on a feedback signal;
generate, by a slope compensation circuit, a compensation signal;
generate a compensated reference signal by adding the compensation signal to the second voltage signal;
generate a gate control signal based on a result of comparison of the first voltage signal and the compensated reference signal; and
control a conductivity state of the second switch by applying the gate control signal to the second gate terminal, thereby maintaining stable circuit operation over a broad range of duty cycles.

2. The circuit of claim 1, wherein the control circuit further comprises a current sensing resistor coupled to the second switch and arranged to generate the first voltage signal.

3. The circuit of claim 1, wherein the compensation signal has a value that starts at a predefined point and has a negative ramp rate.

4. The circuit of claim 1, wherein the circuit is arranged to generate an output voltage such that the output voltage is reduced when an on-time of the second switch is longer.

5. The circuit of claim 1, wherein the slope compensation circuit is arranged to generate the compensation signal having a slope value that suppresses subharmonic oscillation when the circuit operates in continuous and discontinuous conduction modes.

6. The circuit of claim 1, wherein the first switch and the second switch form an asymmetric half-bridge configuration.

7. The circuit of claim 1, wherein the control circuit further comprises:
a peak current reference circuit arranged to generate the second voltage signal based on the feedback signal; and
a comparator having a first input terminal coupled to receive the first voltage signal, a second input terminal coupled to receive the compensated reference signal, and an output terminal arranged to provide the gate control signal.

8. The circuit of claim 1, further comprising:
a transformer having a primary winding coupled to the inductor and a secondary winding;
a resonant capacitor coupled across the primary winding; and
an output rectifier coupled to the secondary winding.

9. The circuit of claim 1, wherein the slope compensation circuit is arranged to generate the compensation signal with a fixed slope value.

10. The circuit of claim 1, wherein the slope compensation circuit is arranged to generate the compensation signal with a variable slope value based on operating conditions of the circuit.

11. A method of operating a circuit, the method comprising:
providing an asymmetric half-bridge circuit having a first switch and a second switch coupled at a switch node, wherein the first switch is coupled to a first terminal of an inductor and the switch node is coupled to a second terminal of the inductor;
detecting a voltage representative of a current flowing through the second switch;
generating a peak current reference signal based on a feedback signal representative of an output parameter of the asymmetric half-bridge circuit;
generating, by a slope compensation circuit, a compensation signal having a negative ramp rate;
combining the compensation signal with the peak current reference signal to generate a compensated reference signal;
comparing the detected voltage with the compensated reference signal to generate a comparison result; and
controlling a gate terminal of the second switch based on the comparison result to maintain stable circuit operation and suppress subharmonic oscillation.

12. The method of claim 11, wherein the generating the compensation signal comprises generating a signal that starts at a predefined value and decreases with a negative slope during an on-time period of the second switch.

13. The method of claim 11, wherein the asymmetric half-bridge circuit operates with a duty cycle greater than fifty percent.

14. The method of claim 11, wherein the asymmetric half-bridge circuit operates at a fixed switching frequency.

15. The method of claim 11, further comprising:
coupling a resonant capacitor across a primary winding of a transformer, wherein the inductor comprises a magnetizing inductance of the transformer; and
suppressing voltage disturbances across the resonant capacitor.

16. The method of claim 11, wherein the detecting the voltage representative of the current comprises measuring a voltage across a current sensing resistor coupled in series with the second switch.

17. The method of claim 16, wherein the compensation signal has a slope value selected to prevent oscillation of an inductor current between successive switching cycles.

18. The method of claim 16, wherein the controlling the gate terminal comprises turning off the second switch when the detected voltage exceeds the compensated reference signal.

19. A power converter system comprising:
a transformer having a primary winding with a first terminal and a second terminal, a secondary winding, and a magnetizing inductance;
a first switch having a first terminal coupled to an input voltage terminal, a second terminal coupled to the first terminal of the primary winding, and a control terminal;
a second switch having a first terminal coupled to the first terminal of the primary winding, a second terminal coupled to a reference potential, and a control terminal;
a resonant capacitor coupled across the primary winding;
a current sensing element coupled to sense current through the second switch;
a peak current reference circuit arranged to generate a reference signal based on a feedback signal representative of an output parameter of the power converter system;
a slope compensation circuit arranged to generate a compensation signal having a negative slope during an on-time of the second switch;
a summation circuit arranged to combine the reference signal and the compensation signal to produce a compensated reference signal;
a comparator having a first input coupled to receive a signal from the current sensing element, a second input coupled to receive the compensated reference signal, and an output; and
a control circuit coupled to the output of the comparator and arranged to control the control terminal of the second switch to prevent subharmonic oscillation in the power converter system.

20. The power converter system of claim 19, wherein the slope compensation circuit is arranged to generate the compensation signal with a slope magnitude that maintains stability when the power converter system operates with a duty cycle greater than fifty percent.
